(19) United States
(12) Patent Application Publication
(10) Pub. No.: US 2008/0209616 A1
(43) Pub. Date: Sep. 4, 2008

(54) Pad for soccer sock

(76) Inventors: James Manning, West Hartford, CT (US); Ahmad J. Manning, West Hartford, CT (US)

Correspondence Address: MCCORMICK, PAULDING & HUBER LLP, CITY PLACE II, 185 ASYLUM STREET, HARTFORD, CT, 06103, US

(21) Appl. No.: 11/712,688

(22) Filed: Mar. 1, 2007

(51) Int. Cl. A41B 11/00; G21F 3/02

(52) U.S. Cl. 2/240; 2/455

(57) ABSTRACT

A soccer sock woven from Lycra/Spandex has a protective pad sewn into the sock, or in a pocket defined in the upper metatarsal prominence area of the sock, to provide protection for the wearer's foot. A tongue portion protects the metatarsal area, and wing portions protect his/her ankle joint. The pad is of closed cell polyurethane foam, and is 3 to 6 millimeters in thickness.

### BACKGROUND OF THE INVENTION

This invention relates to protective gear for soccer players, and deals more particularly with a soccer sock designed to absorb impact forces suffered by the upper metatarsal prominence of the foot, which is susceptible to injury among soccer players. More particularly, the present invention relates to a sock, woven from a synthetic textile material at least in part, and worn with a soccer shoe of conventional configuration.

### SUMMARY OF THE INVENTION

The sock has a portion that overlies the upper metatarsal prominence of the wearer's foot, and a protective pad, preferably of closed cell polyurethane foam, is provided in a pocket, or stitched inside the sock to locate the pad relationship to the foot instep and the ankle, to protect the foot from injuries due to impact forces in this area of the foot, whether caused by kicking of the soccer ball, or whether caused by impact with other players, particularly from the studs or cleats of a soccer shoe worn by another soccer player.

While the entire sock may be woven from synthetic textile material, such as a polymeric yarn for example, this invention can be practiced in a sock woven at least partially of Lycra (a Dupont trademark for Spandex). The pocket portion is also preferably woven from a material of this type, but the sock may be woven from a combination of such material (10%) and Nylon (90%).

The pad is preferably three (3) to six (6) millimeters in thickness, and is so shaped that a lower edge thereof, at the lower edge of the pocket, is spaced above the wearer's toes. The opposite or upper edge of the polyurethane closed cell foam pad, extends up to at least the ankle joint of the foot so that projecting wing portions of the pad can wrap around the ankle bone to protect the ankle joint.

As a result of this construction, the area of the foot which will be protected by the pad is the upper metatarsal prominence or instep of the wearers foot, and the ankle joint.

The foam pad is of closed cell polyurethane and is of a slow rebounding type, which is quite flexible. The closed cell character of the foam decreases the water absorption of the foam pad.

### BRIEF DESCRIPTION OF DRAWINGS

FIG. 1 is a perspective view of a pad suitable for use in a sock of the type and material commonly used by soccer players.

FIG. 2 shows a foot having the pad of FIG. 1 sewn into a pocket defined for this purpose in the sock. A soccer shoe is illustrated in broken lines, and the location for the laces as provided in a typical soccer shoe is also illustrated in broken or phantom lines in FIG. 2.

FIG. 3 is a sectional view through the pad and sock of FIG. 2.

FIG. 4 shows an alternative embodiment for holding the pad in a pocket defined in the sock.

### DETAILED DESCRIPTION

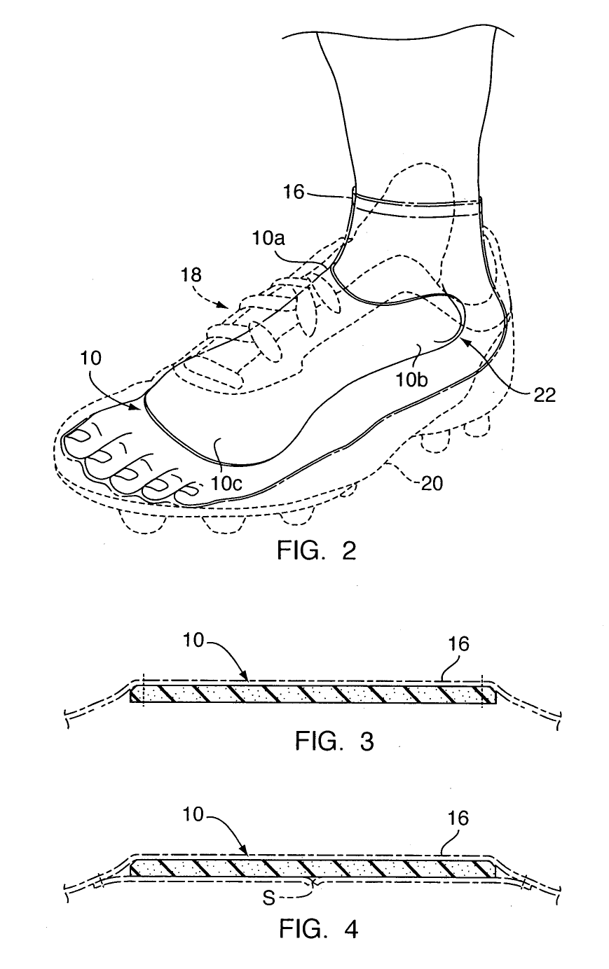

Turning now to the drawings in greater detail, FIG. 2 shows a soccer player's foot, with the outline of a soccer shoe 20 indicated in phantom lines. In accordance with the present invention, the soccer player is wearing a sock 16, the sock being fitted with a protective pad 10. The pad is so located as to protect the upper metatarsal prominence of the wearer's foot and is located immediately behind the laced area 18 of the shoe 20. These portions of the soccer shoe are shown for background only, and in broken or phantom lines in FIG. 2.

It is important to note that the pad 10 has wing portions such as indicated at 10a and at 10b, that generally cover the area indicated at 22, namely the ankle joint of the foot. Still with reference to FIG. 2, the pad 10 has a lower portion or edge 10c that is provided immediately above the toes of the wearer's foot.

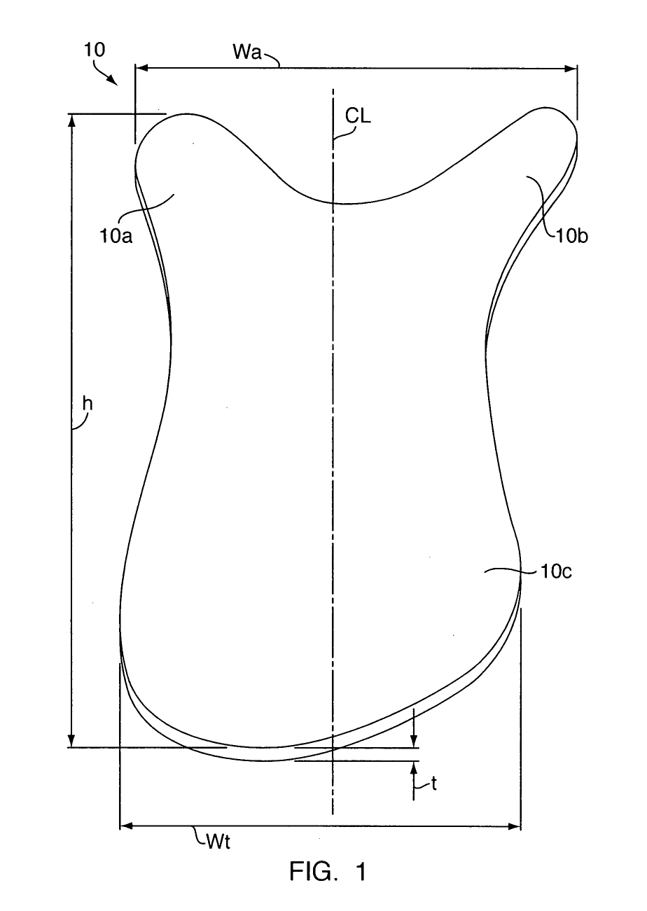

FIG. 1 shows the geometry of the pad in somewhat greater detail, and from FIG. 1 it will be seen that the wing portions 10a and 10b are not symmetrical with respect to a center line C/L in FIG. 1. These wing portions project beyond the width Wt of a tongue portion 10c of the pad. The tongue portion being designed to reside behind the laces of the soccer shoe itself.

Still with reference to FIG. 2, but shown in greater detail in FIG. 3 is the cross-section of the pad 10. As seen in FIG. 3 the pad comprises a polyurethane foam which is of the closed cell variety and firm enough to provide a slow rebound protective device for the wearer's foot. The foam portion comprises the entire thickness t of the pad 10 and is preferably in the range of between three to six millimeters.

The unstitched pad itself is not symmetrical with reference to the above mentioned center line C/L. However it may be reversible so the same shape can be used when worn on the left or the right foot.

The wing span Wa of these wing portions 10a and 10b will preferably be somewhat less than the total height h of the pad, which is preferably about twice that of the width Wt of the tongue portion of the pad. The total height dimension h is at least equal to Wa, and preferably h is 50% greater than Wa.

In it's preferred form the sock is woven from synthetic textile yarn, preferably a combination of Nylon and Spandex in the proportions of 90% Nylon and 10% Spandex.

The sock 10 is conventional, except for the fact that the pad 10 is either sewn into the sock, or provided in a pocket sewn into the sock, at the instep portion generally opposite the heel portion. The pad is preferably sewn around the entire periphery and if a pocket is provided, the pocket may have an opening into which the pad can be inserted. A slit 12 may be provided in the pocket for replacing the pad, but the pad material is selected to allow washing of the sock with the pad sewn in place. The pad material is preferably PORON, a polyurethane foam available from Rogers Corporation of Connecticut. Such material is a closed cell foam having very minimal water absorbency. This material has been found to have a moisture absorbency of less than 10%.

The soccer sock of the present invention preferably has the pad sewn directly to the sock as suggested in FIG. 3. The sock itself is fabricated from the above mixture of Nylon and Spandex.

Alternatively the sock may have a pocket provided of the same material as that used in the sock. The sock and the pocket defining portion on the inside of the sock is defined by a woven material of one hundred (100) percent Lycra/Spandex or equivalent. The pad may instead be accessible through slit S in the above described pocket.

The pad is preferably sewn in place, by means of conventional stitching, either peripherally as suggested in FIG. 3, or in the form of a pattern that allows a logo to be displayed through the sock, and that is visible when the sock is worn.

We claim:

1. A sock woven from textile material for wearing with a soccer shoe, and a protective synthetic foam pad secured in the upper metatarsal prominence area of the sock, said pad comprising a firm, slow rebound, foam material, said foam pad having a thickness in the range of three (3) to six (6) millimeters and being of closed cell polyurethane material.

2. The sock according to claim 1, wherein said pad has a tongue portion with a lower edge provided above the wearer's toes, and an upper portion of said pad opposite said pad lower portion, said upper portion provided with projecting wings for protecting the wearer's ankle joint.

3. The sock according to claim 1, wherein said pad is stitched directly to said sock and held in a position overlying said upper metatarsal prominence area of the foot.

4. The sock according to claim 1, wherein said sock has a pocket for receiving said pad, and at least one opening for removal and replacement of the pad.

5. The sock according to claim 1, wherein said sock is woven from a combination of Nylon, and Lycra (or Spandex).

6. The sock according to claim 5, wherein said pad has a tongue portion with a lower edge provided above the wearer's toes, and an upper portion of said pad opposite said pad lower portion, said upper portion provided with projecting wings for protecting the wearer's ankle joint.

7. A protective device for the human foot, said device comprising:
a sock having a toe portion, a heel portion, a sole portion, and a portion for overlying the foot's instep, said sock portions being connected to one another for proper placement of said portion overlying the instep on the foot when the sock is worn by a user; and
a pad provided at said portion overlying the user's instep, said pad having a generally uniform thickness in the range between three (3) to six (6) millimeters, and said pad being so shaped that a lower tongue portion is spaced above the user's toes, and an upper portion of said pad having wings that wrap around the foot at the top of the user's instep to protect the ankle joint.

8. The device of claim 7 further characterized by pocket means for holding said pad inside said sock at said portion overlying the user's instep.

9. The device of claim 7 where said pad is formed from a closed cell slow rebound polyurethane foam.

10. The sock of claim 1 further including means for retaining said pad in said sock, and said means comprising sewing said pad to said sock.

11. The device of claim 10, wherein said pad is formed from a closed cell slow rebound polyurethane foam.

12. The sock of claim 7, further including means for retaining said pad to said sock, said means comprising stitches between said sock and said pad, said stitching also defining a logo.

13. The sock of claim 6, wherein said pad has a height (h) at least 50% greater than the lateral dimension or wing span (Wa) of said upper portion.

14. The device of claim 7, wherein said pad has a height (h) greater than the lateral dimension or wing span (Wa) of said upper portion.
